(19) United States
(12) Patent Application Publication
(10) Pub. No.: US 2012/0110992 A1
(43) Pub. Date: May 10, 2012

(54) ELECTRIC CAPSTAN

(75) Inventor: Mingkui ZHENG, Ningbo City (CN)

(73) Assignee: NINGBO CHIMA WINCH CO., LTD., Ningbo City (CN)

(21) Appl. No.: 13/183,380

(22) Filed: Jul. 14, 2011

(30) Foreign Application Priority Data
Nov. 9, 2010 (CN) 201020612033.9
Jan. 20, 2011 (CN) 201120018109.X

(51) Int. Cl. F15B 17/00

(52) U.S. Cl. 60/435

(57) ABSTRACT

An electric capstan that is able to save power and make use more convenient. The electric capstan includes an air pump, a motor, a reduction gear and a winching roller, and further includes an engagement-disengagement gear, wherein the input shaft of the air pump is connected to or separated from the output shaft of the motor by the engagement-disengagement gear.

### CROSS-REFERENCE(S) TO RELATED APPLICATION(S)

This application claims priority to Chinese Patent Application No. 201020612033.9, filed Nov. 9, 2010, and to Chinese Patent Application No. 201120018109.X, filed Jan. 20, 2011, each of which is hereby incorporated by reference in the present disclosure in its entirety.

### BACKGROUND

1. Field

The present disclosure relates generally to capstans, and more specifically to electric capstans.

2. Description of Related Art

Electric capstans are mainly used in off-road vehicle, agricultural vehicle, barge and other special vehicles, and are used as a self-protection device and a traction device for a vehicle or a ship. In the case of driving vehicles or ships for purpose of traction operation and rescue operation (including self-rescue operation), electric capstans act an important part.

There is an electric capstan in the related art, which includes an air pump, a motor, a reduction gear and a winching roller, wherein the output shaft of the motor at one end thereof is connected to the input shaft of the air pump, the output shaft of the motor at the other end thereof is connected to the reduction gear, and then the reduction gear is connected to the winching roller. This can accomplish a multi-functional electric capstan, namely traction function and inflation function. However, since output shaft of the motor of the electric capstan is directly connected to the input shaft of the air pump, the motor may always drive the air pump. As a result, when inflation is not required, this causes much power to be consumed and wasted, which is unexpected and brings the user inconvenience.

### BRIEF SUMMARY

One object of the present disclosure is to provide an electric capstan which is able to save power and make use convenient.

In one embodiment, the object of the present disclosure can be accomplished using the following configuration: An electric capstan of the disclosure includes an air pump, a motor, a reduction gear and a winching roller, and further includes an engagement-disengagement gear, wherein the input shaft of the air pump is connected to or separated from the output shaft of the motor by the engagement-disengagement gear.

Compared with the related art, the present disclosure, with such above configuration, has following advantages. The electric capstan according to the present disclosure further includes an engagement-disengagement gear, wherein the input shaft of their air pump is connected to or separated from the output shaft of the motor by the engagement-disengagement gear. As a result, this can allow the user to start or stop the air pump arbitrarily, so that the present disclosure has advantages in saving power and convenient use.

As a modification, the engagement-disengagement gear includes a clutch and a lever that is able to engage or disengage the clutch, wherein the clutch has a groove, the lever at the end thereof has an eccentric and axial protrusion which can be embedded in the groove of the clutch, and the lever is rotatably attached to the housing of the clutch. This engagement-disengagement gear has a simple and reliable structure, high transmission efficiency and easy manipulation, which is advantageous to implement the electric capstan according to the present disclosure and improve the performance thereof.

As a further modification, the electric capstan according to the present disclosure further includes a transmission mechanism, the input end of which is connected to the output end of the motor, and the output end of which is located on the side face of motor and connected to the input shaft of the air pump. As a result, since the air pump is located on the sideface of the motor, the dimension of the electric capstan in the axial direction thereof can greatly reduce, that is the dimension of the electric capstan in the lengthwise direction thereof can greatly reduce, and therefore, the electric capstan according to the present disclosure has an advantage that it can be mounted on an object which provides a narrow mounting place.

As a further modification, the transmission mechanism is a gear transmission mechanism which includes a bracket, a first gear, a second gear and a third gear, wherein the bracket is connected to the housing of the motor, the output shaft of the motor extends into the bracket, the housing of the air pump is connected with the bracket, and the input shaft of the air pump extends into the bracket; the connection of the input end of the transmission mechanism and the output shaft of motor means the connection of the first gear and the output shaft of motor; the second gear is mounted on the bracket; the connection of the output end of the transmission mechanism and the input shaft of the air pump means the connection of the third gear and the input shaft of the air pump; the first gear, the second gear and the third gear are engaged successively. As a result, since the three gears constitute the gear transmission mechanism, the electric capstan according to the present disclosure has a simple structure and reduced weight, and therefore, it is easy to be mounted on transportation such as a vehicle.

As a further modification, the air pump is located above the sideface of the motor. As a result, this can make the whole structure of the electric capstan more compact and mounting of the air pump more convenient.

As a further modification, a speed change mechanism may be arranged between the output end of the transmission mechanism and the input shaft of the air pump. The output end of the transmission mechanism, the speed change mechanism and the input shaft of the air pump are connected successively. As a result, through the speed change mechanism, the revolution speed outputted by the output end of the transmission mechanism can match further more air pumps available from market, thus increasing productive efficiency and reducing cost.

As a further modification, the engagement-disengagement gear is an engagement-disengagement handle that can be operated so as to move the second gear in the axial direction of the revolution shaft thereof and further engaged with or disengaged from the first gear, wherein the engagement-disengagement handle is mounted on the bracket, and the operational end of the engagement-disengagement handle is located on the side of the second gear. This engagement-disengagement gear has a simple and reliable structure, reduced cost and easy manipulation. Furthermore, the engagement-disengagement gear is arranged on the transmission mechanism, thus making the whole structure of the electric capstan more compact. This is advantageous to implement the electric capstan according to the present disclosure and improve the performance thereof.

### DESCRIPTION OF THE FIGURES

FIG. 1 is an exemplary structural view of the electric capstan according to the first embodiment of the present disclosure;

FIG. 2 is an exemplary cross-sectional view, in enlarged manner, showing the engagement-disengagement gear of the electric capstan according the first embodiment of to the present disclosure;

FIG. 3 is an exemplary structural view of the electric capstan according to the second embodiment of the present disclosure; and

FIG. 4 is another exemplary structural view of the electric capstan according to the second embodiment of the present disclosure.

In the figures, reference numeral 1 indicates an air pump, reference numeral 2 indicates a motor, reference numeral 3 indicates a winching roller, reference numeral 4 indicates a clutch, reference numeral 5 indicates a lever, reference numeral 6 indicates a bracket, reference numeral 7 indicates a first gear, reference numeral 8 indicates a second gear, reference numeral 9 indicates a third gear and reference numeral 10 indicates an engagement-disengagement handle.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

The details of the present disclosure are set forth in the accompanying drawings and the embodiments below.

### First Embodiment

In the first embodiment of the present disclosure, an electric capstan includes an air pump 1, a motor 2, a reduction gear and a winching roller 3. The electric capstan further includes an engagement-disengagement gear, and the input shaft of the air pump 1 is connected to or disconnected from the output shaft of the motor 2 by the engagement-disengagement gear. The motor 2, the reduction gear and the winching roller 3 are available from prior art, and thus the descriptions thereof are omitted.

The engagement-disengagement gear includes a clutch 4 and a lever 5 that is able to engage or disengage the clutch 4. The clutch 4 has a groove, and the lever 5 at the end thereof has an eccentric and axial protrusion which can be embedded in the groove of the clutch. The lever 5 is rotatably attached to the housing of the clutch 4.

A speed change mechanism, which is able to increase or reduce speed and which may be conventionally available from the market, may be arranged inside the air pump 1. For example, the rotation speed of the motor 2 relates to the traction power range of the electric capstan, and therefore, in this embodiment, the electric capstan is designed as follows:

When the traction capacity range of the electric capstan is between 1500-6000 pounds, the air pump 1 is unnecessarily provided with the reduction mechanism.

When the traction capacity range of the electric capstan is between 8000-13000 pounds, the air pump 1 is necessarily provided with the reduction mechanism.

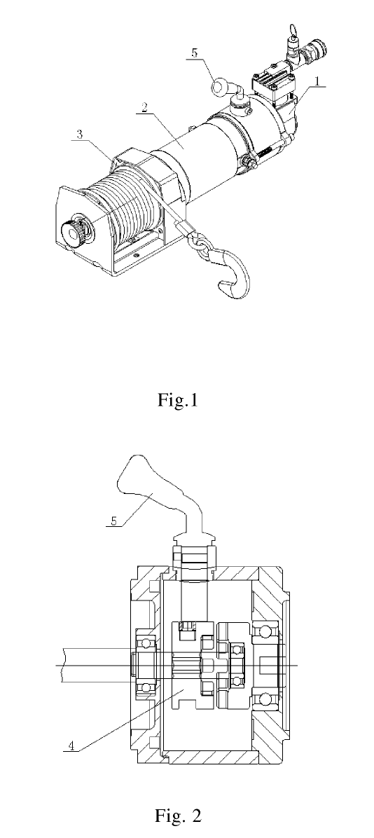

In the first embodiment, the air pump 1, the motor 2, the engagement-disengagement gear, the reduction mechanism and winching roller 3 align in a same axis. Such above configuration is shown in FIG. 1 or 2.

### Second Embodiment

In the second embodiment of the present disclosure, an electric capstan includes an air pump 1, a motor 2, a reduction gear and a winching roller 3. The electric capstan further includes an engagement-disengagement gear, and the input shaft of the air pump 1 is connected to or disconnected from the output shaft of the motor 2 by the engagement-disengagement gear.

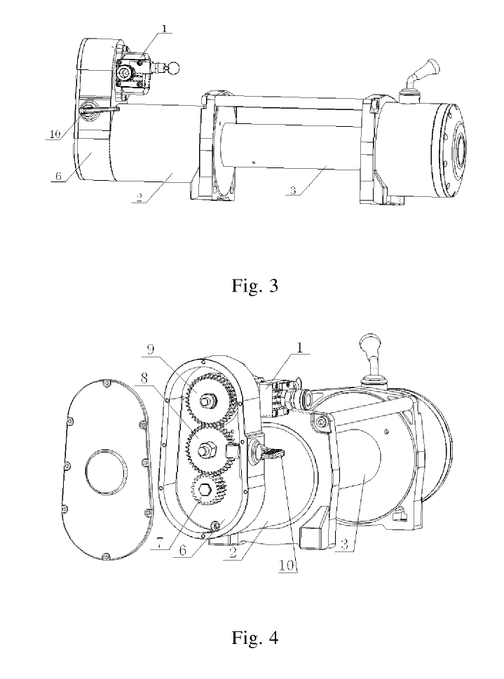

The electric capstan further includes a transmission mechanism, the input end of which is connected to the output shaft of the motor 2, and the output end of which is located on the side face of motor 2 and connected to the input shaft of the air pump 1. The output shaft of the motor 2 is also connected to the reduction gear, and then the reduction gear is connected to the winching roller 3. The motor 2, the reduction gear and the winching roller 3 are available from prior art, and thus the descriptions thereof are omitted. Such above configuration is shown in FIG. 3 or 4.

The transmission mechanism is a gear transmission mechanism that includes a bracket 6, a first gear 7, a second gear 8 and a third gear 9. The bracket 6 is connected to the housing of the motor 2, the output shaft of the motor 2 extends into the bracket 6, the housing of the air pump 1 is connected with the bracket 6, and the input shaft of the air pump 1 extends into the bracket 6. The connection of the input end of the transmission mechanism and the output shaft of motor 2 means the connection of the first gear 7 and the output shaft of motor 2. The second gear 8 is mounted on the bracket 6. The connection between the output end of the transmission mechanism and the input shaft of the air pump 1 means the connection of the third gear 9 and input shaft of the air pump 1. The first gear 7, the second gear 8 and the third gear 9 are engaged successively.

The engagement-disengagement gear is an engagement-disengagement handle 10 that can be operated so as to move the second gear 8 in the axial direction of the revolution shaft thereof and further engaged with or disengaged from the first gear 7, wherein the engagement-disengagement handle 10 is mounted on the bracket 6, and the operational end of the engagement-disengagement handle 10 is located on the side of the second gear 8.

The air pump 1 is located above the side face of motor 2, and the axis of the input shaft of the air pump 1 is in parallel with the axis of the output shaft of the motor 2.

A speed change mechanism (not shown), which is able to increase or reduce speed and which may be available from the related art, may be arranged between the output end of the transmission mechanism and the input shaft of the air pump 1. The output end of the transmission mechanism, the speed change mechanism and the input shaft of the air pump 1 are connected successively. In addition to provision of the speed change mechanism between the output end of the transmission mechanism and the input shaft of the air pump 1, in this embodiment, a speed change mechanism built-in air pump 1 as the first embodiment may be adopted.

What is claimed is:

1. An electric capstan comprising:
an air pump,
a motor,
a reduction gear,
a winching roller, and
an engagement-disengagement gear,
wherein the input shaft of the air pump is connected to or disconnected from the output shaft of the motor by the engagement-disengagement gear.

2. The electric capstan according to claim 1, wherein:
the engagement-disengagement gear includes a clutch and a lever that is able to engage or disengage the clutch, wherein the clutch has a groove, the lever at the end thereof has an eccentric and axial protrusion which can be embedded in the groove of the clutch, and the lever is rotatably attached to the housing of the clutch.

3. The electric capstan according to claim 1, further comprising:
a transmission mechanism, the input end of which is connected to the output shaft of the motor, and the output end of which is located on the side face of motor and connected to the input shaft of the air pump.

4. The electric capstan according to claim 3, wherein:
the transmission mechanism is a gear transmission mechanism that includes a bracket, a first gear, a second gear and a third gear, wherein the bracket is connected to the housing of the motor, the output shaft of the motor extends into the bracket, the housing of the air pump is connected with the bracket, and the input shaft of the air pump extends into the bracket;
the connection of the input end of the transmission mechanism and the output shaft of motor means the connection of the first gear and the output shaft of motor;
the second gear is mounted on the bracket;
the connection of the output end of the transmission mechanism and the input shaft of the air pump means the connection of the third gear and input shaft of the air pump; and
the first gear, the second gear and the third gear are engaged successively.

5. The electric capstan according to claim 3, wherein:
the air pump is located above the sideface of the motor.

6. The electric capstan according to claim 3, further comprising:
a speed change mechanism arranged between the output end of the transmission mechanism and the input shaft of the air pump, and the output end of the transmission mechanism, the speed change mechanism and the input shaft of the air pump are connected successively.

7. The electric capstan according to claim 4, wherein:
the engagement-disengagement gear is an engagement-disengagement handle that can be operated so as to move the second gear in the axial direction of the revolution shaft thereof and further engaged with or disengaged from the first gear, wherein the engagement-disengagement handle is mounted on the bracket, and the operational end of the engagement-disengagement handle is located on the side of the second gear.
